(19) United States
(12) Patent Application Publication
(10) Pub. No.: US 2009/0146450 A1
(43) Pub. Date: Jun. 11, 2009

(54) Deployable Pick-Up Truck Cargo Bed Cover

(76) Inventor: Amal Flores, Los Angeles, CA (US)

Correspondence Address: CARLOS CANDELORO, 1601 N. SEPULVEDA BLVD., # 239, MANHATTAN BEACH, CA, 90266, US

(21) Appl. No.: 12/198,888

(22) Filed: Aug. 27, 2008

Related U.S. Application Data
(60) Provisional application No. 60/966,482, filed on Aug. 27, 2007.

(51) Int. Cl. B60J 11/06

(52) U.S. Cl. 296/136.03

(57) ABSTRACT

A tonneau cover deployable into a lumber-type rack includes a cover that when mounted on a pick-up truck bed is generally adapted to slide back from a first position where the cover secures the pick-up truck bed to a second position where the front portion of the pick-up truck bed is uncovered and from said second position the cover is deployable into a third position where it may function as a lumber type rack.

This application claims the benefit of U.S. Provisional Application No. 60/966,482, filed Aug. 27, 2007, which is hereby incorporated by reference.

### FIELD OF THE INVENTION

The invention relates to pick-up truck accessories, in particular cargo bed accessories.

### BACKGROUND OF THE INVENTION

Pick-up trucks have never been more popular. These vehicles generally include a regular or extended forward cab and an open rear storage compartment or “cargo bed.” The cargo bed in pick-up trucks generally is open on top, and enclosed by front, left and right panels, a floor and a rear tailgate. The rear tailgate generally swings open by pivoting around either its bottom edge or a side edge.

Accessories are available to increase the functionality of pick-up trucks, including accessories for the cargo bed. Popular cargo bed accessories include lumber or ladder type overhead racks. These racks are generally attached to the cargo bed and permit carrying overhead objects longer or larger than the cargo bed. Although very functional, fixed lumber type racks present certain disadvantages based primarily on their size and the fact that they are always deployed. One such disadvantage, for example, is their unfavorable aerodynamic profile. Another disadvantage is that lumber racks are considered aesthetically unpleasant by some; in particular the racks can make a pick-up truck look like a “work truck” when in fact the vehicle is also a personal vehicle.

Another accessory commonly installed on the cargo bed of pick-up trucks is generally known as a “tool box.” Tool boxes generally permit securing items in a locked box that is positioned on the front portion of the cargo bed, generally abutting the cargo bed's front panel. Tool boxes present several advantages, including that they prevent items placed in them from sliding in the cargo bed when the pick-up truck is in motion, while holding the items in what some consider a favorable position from a center of gravity standpoint. Tool boxes are generally also of a sturdy and secure construction, and permit items to be locked therein in relative safety. Tool boxes however also present certain disadvantages, including, for example, that they decrease the space available in the cargo bed for larger items. To remedy this problem, sometime tool boxes are used in conjunction with overhead lumber racks. However this requires the purchase and installation of two different accessories, the toolbox and the lumber rack. Tool boxes also are believed to generally not improve the aerodynamic profile of a cargo bed. The negative aerodynamic profile of a cargo bed is believed generally to be caused by the open top of the cargo bed in combination with vertical disposition of the rear tailgate door, an aspect toolboxes generally do not appear to improve in any significant manner.

Another accessory commonly installed on the cargo bed of pick-up trucks is generally known as a truck bed cover or tonneau cover. Tonneau covers are generally made of fiberglass or the like and cover the entire truck bed by resting on top of the rails of the front, left and right panels and the tailgate. Tonneau covers are generally believed to improve the aerodynamic performance of pick-up trucks. They also generally prevent water, dust and other elements from falling into the truck bed, and provide some measure of security by preventing visual inspection of the contents of the cargo bed and because they may be locked. Tonneau covers are also generally perceived as improving the aesthetics of pick up trucks, and are made to match the style and color of the truck on which they are meant to be installed. Because of their placement, tonneau covers are generally incompatible with overhead lumber racks. Tonneau covers are generally not weight bearing and accordingly do not provide tie-downs that would permit items to be placed on top of the tonneau cover. Traditional tonneau covers generally may be opened by lifting the back edge of the tonneau while the tonneau rotates pivotally around its front edge. This traditional mechanism disadvantageously limits access to the front of the cargo bed. Limited access to the front of the cargo bed is incompatible with a front tool box type accessory and with the favorable placement and securing of items on the front portion of the cargo bed.

Cargo bed covers that are deployable into overhead racks are known. For example, in U.S. Pat. No. 5,110,021 to Dawson, a combination rack, locker and extended side walls has two doors, each hinged respectively to the top edges of opposing sidewalls of the truckbed. The doors close over the truckbed to form a lockable enclosure or may be oriented to an upright position and fixed by a pair of rack members extending across the truckbed. The system in Dawson presents several disadvantages, including that lateral access to the cargo bed is impeded by the doors. The system also requires assembly of the rack members to deploy the overhead rack.

In U.S. Pat. No. 7,118,159 to Andrews, a base frame attaches to and outlines an upper periphery of the truck bed. A pair of door assemblies is pivotally attached to the frame on opposite sides of the longitudinal midline of the frame that runs from the head of the truck bed to the tailgate. Each door assembly pivots between a closed position covering the bed and an open position extending diagonally upwardly from the frame. In the open position each door assembly has kickstands that pivot downward and secure within the frame while brackets connect between the two door assemblies in order to form a material carrying rack. Accordingly, while this system in Andrews addresses the issue of lateral access to the cargo bed, the system still presents significant disadvantages. In particular, deploying the material carrying rack entails a significant amount of assembly, requiring, inter alia, mounting the brackets, etc., that connect between the two door assemblies in order to form the material carrying rack. Moreover, the seam along the median to which the door assemblies are pivotally mounted can result in water leaks and the like.

Accordingly, there is a need for a tonneau cover deployable into a lumber rack that is simple to manufacture, install, and operate. There is also a need for a tonneau cover that can provide the aerodynamic and aesthetic advantages of existing tonneau covers while also converting to a lumber type rack with minimum need for assembly. There is also a need for a tonneau cover that can provide easy and simple lateral access to the front portion of the cargo bed.

### BRIEF DESCRIPTION OF THE INVENTION

In a first, separate aspect of the present invention, a tonneau cover deployable into a lumber-type rack includes a cover that when mounted on a pick-up truck bed is generally adapted to slide back from a first position where the cover secures the pick-up truck bed to a second position where the front portion of the pick-up truck bed is uncovered and from said second position the cover is deployable into a third position where it may function as a lumber type rack.

In a second, separate aspect of the present invention, a tonneau cover deployable into a lumber-type rack includes a casing adapted to securely cover a pick-up truck bed; a left track and a right track adapted to be securely attached to left and right cargo bed side panels of a pick-up truck bed, respectively, and further adapted to slidingly engage one or more carriages; and one or more post assemblies, which slidingly and deployably connect the casing to the tracks. The post assemblies generally include a post having a first end and a second end; an upper hinge, the upper hinge adapted to pivotally connect the post's first end to the casing; a carriage; a lower hinge, the lower hinge adapted to pivotally connect the post's second end to the carriage. The carriage is generally adapted to engage and slide along the track or rail. A carriage stop or locking mechanism is adapted, when engaged, to prevent the sliding of the carriage on the track along one or two ways, respectively. A securing mechanism releasably secures the tonneau cover in a deployed position. The assembled tonneau cover is generally adapted to slide back from a first position where the tonneau cover secures the pick-up truck bed to a second position where the front portion of the pick-up truck bed is exposed and from said second position the tonneau cover is deployable into a third position where the assembled and deployed tonneau cover may function as a lumber type rack.

In a third, separate aspect of the present invention, a truck bed cover deployable into a lumber rack includes a first load bearing structure adapted to securely cover a truck bed, the first load bearing structure adapted to define a load bearing plane substantially parallel to that of a truck bed; a sliding mechanism adapted to permit the first load bearing structure to slide horizontally from a first position where the first load bearing structure substantially covers the entire truck bed to a second position where the front portion of a truck bed is not covered by the first load bearing structure; a second load bearing structure functionally attachable to a truck bed and functionally engageable to the first load bearing structure, the second load bearing structure adapted to be deployable into a substantially vertical load bearing position and adapted to lift the first load bearing structure from the second position to a third position in which the load bearing plane defined by the first load bearing structure is substantially parallel to a truck bed at a height that clears a roof of a passenger cabin of a truck.

In a fourth, separate aspect of the present invention, a mechanism for slidingly and deployably mounting an accessory to a pick-up truck bed generally includes a carriage, the carriage being adapted to slidingly engage a track of the type adapted to be mounted on a pick-up truck bed; a post, the post having a first end and a second end, wherein the first end is hingedly attached to the carriage and the second end is adapted to be attached to an accessory; a carriage stop mechanism, said carriage stop mechanism being adapted in a first, non engaged position, to permit said carriage to travel freely back and forth on a said track, and in a second, engaged position, to prevent the movement of the carriage along said track; a securing mechanism, the securing mechanism being adapted to secure the mounting mechanism in a deployed position.

### DESCRIPTION OF THE FIGURES

It should be understood that the drawings are provided for the purpose of illustration only and are not intended to define the limits of the invention. The foregoing and other objects and advantages of the embodiments described herein will become apparent with reference to the following detailed description when taken in conjunction with the accompanying drawings in which:

FIG. 1 is an exploded view illustrating certain components of a deployable tonneau type truck-bed cover in accordance with an embodiment of the present invention. The figure shows a left side portion of an embodiment of a mechanism enabling the sliding/deployment action of the deployable tonneau type truck-bed cover in accordance with an embodiment of the present invention. The right side of the mechanism, which is not shown in the figure, generally is a mirror image of the left side along the medial plane.

FIGS. 2A-C are perspective view illustrations of a truck-bed accessory including a tonneau type cover deployable into a lumber type rack in accordance with an embodiment of the present invention. As illustrated, the truck bed accessory is mounted via a mechanism that permits the accessory to be slidingly (FIGS. 2A-2B transition) and deployably (FIGS. 2B-2C transition) mounted on the bed of a pick-up truck.

FIG. 3 is a side view cross-section that includes a generic illustration of the front edge of an accessory mounted via a mechanism in accordance with an embodiment of the present invention, in this case in a first (closed) position (see, e.g., FIG. 2A). The figure includes a generic illustration of the disposition of a post assembly in accordance with this embodiment of the invention. Also shown is a generic illustration of a strike-catch mechanism for securing the accessory in the closed position.

FIG. 4 is a side view cross-section type illustration that includes the edge of an accessory mounted via a mechanism in accordance with an embodiment of the present invention, in this case as the accessory lies in a second (open) position (see, e.g., FIG. 2B). The figure includes an illustration of a post assembly, which in the embodiment shown slides with the accessory along the tracks. Also shown are carriage lock/stop mechanisms in accordance with one embodiment of the invention.

FIG. 5 is a side cross-section type illustration that includes a front portion of an accessory mounted via a mechanism in accordance with an embodiment of the present invention, in this case as the accessory lies in a deployed position (see, e.g., FIG. 2C). The figure also includes an illustration of a post assembly in the deployed position, supporting the accessory overhead in accordance with this embodiment of the invention. Also shown is an illustration of a securing mechanism—in this case a strike-catch mechanism—that secures the accessory in a deployed position.

FIG. 6 is an illustration of a cross section along line 6 in FIG. 5.

FIG. 7 is an illustration of a cross section along line 7 in FIG. 5.

### DETAILED DESCRIPTION OF THE DRAWINGS

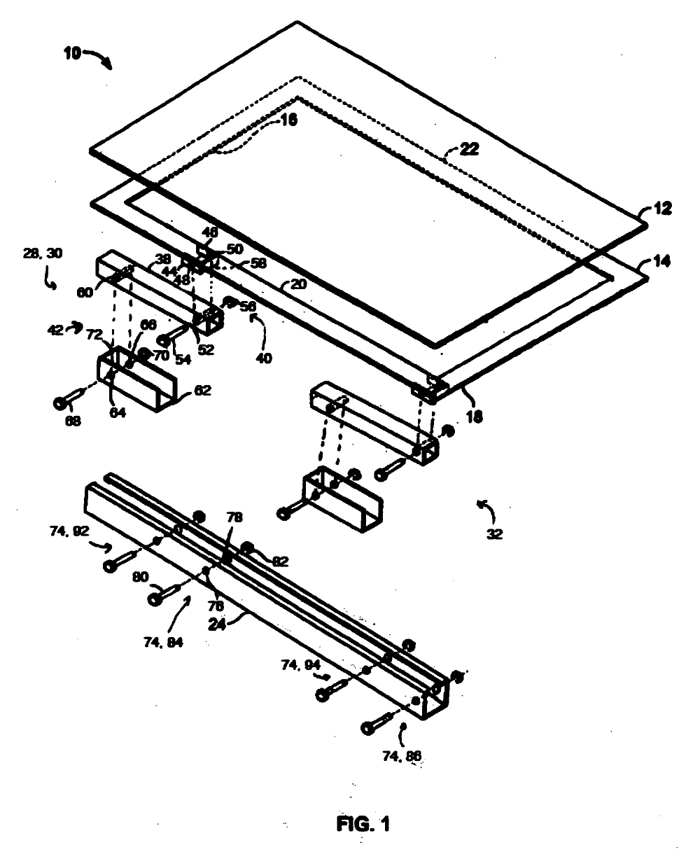

Turning now in detail to the figures, where FIG. 1 is an exploded view illustrating certain components of a convertible tonneau cover accessory 10 in accordance with an embodiment of the present invention. The convertible tonneau cover 10 includes a thin rigid casing 12 attached to, or integrally formed with, a structural framework 14. Alternatively the cover may itself be structural and/or weight bearing. In the embodiment shown, the structural framework 14 includes a front cross-beam 16, a back cross-beam 18, a left beam 20 and a right beam 22. Rails, tie-downs, or the like, (not shown) that permit securing articles to the top side of the cover may also be present.

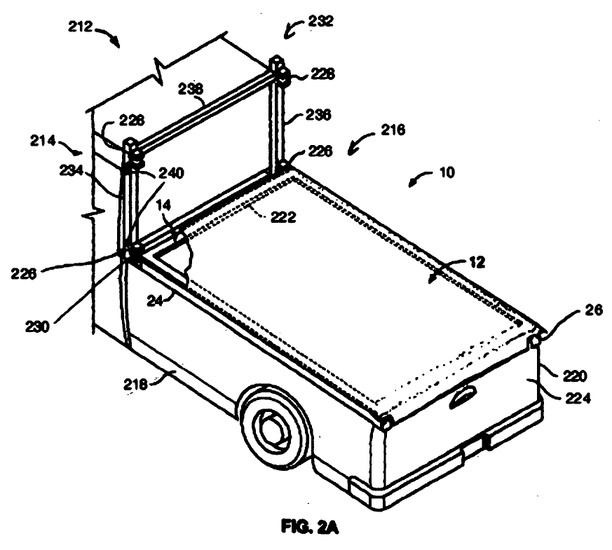

As may be seen in FIGS. 2A-C, the rigid casing 12/structural framework 14 is slidingly and deployably mounted on one or more tracks, rails, or the like 24, 26 via one or more post assemblies 28. In the embodiment shown, front left 30, back left 32, front right 34 and back right 36 post assemblies 28, slidingly and deployably mount the rigid casing 12/structural framework 14 to a left track 24 and a right track 26, respectively.

In the embodiment shown, each post assembly 28 generally includes a post 38, an upper, first hinge structure 40 and a lower, second hinge structure 42. The upper hinge structure 40 may be formed in any operative manner. In the embodiment shown it is formed by two opposing hinge plates 44, 46 that have a through orifice 48, 50 and are positioned on the structural framework 14 in a manner adapted to receive a first end of the post 38, which also has a through orifice 52, such that the hinge plates 44, 46 and post 38 form a hinge upon receiving a hinge pin 54, rod, or the like. Once threaded through the orifices, 48, 52, 50 the hinge pin 54 in the embodiment shown is secured by a clasp 56, or the like. In the embodiment shown, stop plate 58, or the like, is present to prevent the post 38 from hyperextending, e.g., swinging past an angle perpendicular to the structural framework 14. Other mechanisms may alternatively or additionally be used to prevent the post 38 from overextending, or to reinforce the structure.

Each post assembly 28 generally also includes a lower, second hinge structure 42. The second hinge structure 42 may be formed in any operative manner. In the embodiment shown, the second hinge structure 42 is formed between the second end of a post 38, which has a second through orifice 60, and a sliding carriage 62, or the like. In the embodiment shown, the carriage has a pair of opposing through orifices 64, 66 such as to form a hinge structure upon receiving a carriage hinge pin 68, rod, or the like. In the embodiment shown, the carriage hinge pin 68 is generally secured by a clasp 70, or the like. In the embodiment shown, a carriage stop plate 72, or the like, prevents post 38 from hyperextending, e.g., swinging past a perpendicular angle when it engages the carriage 52 in second hinge structure 42. Other mechanisms may alternatively or additionally be used, for example, to hingedly mount post to carriage, to prevent the post from overextending, to reinforce the structure, and the like.

In the embodiment shown, each post assembly's 30, 32, 34, 36 carriage 72 is generally adapted to be slideably mounted on a track, rail, or the like. In the embodiment shown, front 30 and back 32 left post assemblies are slideably mounted on a left track 24, while front 34 and back 36 right post assemblies are slideably mounted on a right track 26. In the embodiment shown, the carriage 72, or the like, is adapted to slide front-to-back along the track it is mounted on 24, 26 while also being securely fastened to the track 24, 26 such as to prevent lateral, vertical, and rotational or pivoting type movements.

One or more carriage locking mechanisms are operatively arranged to control the movement of the carriages 72 along the tracks 24, 26. The carriage locking mechanism may be formed in any operative manner. Mechanisms may include, for example, hitch pins, threadable bolts, bolt and nut, or other easily actuated travel stop and carriage locking mechanism that permits locking a carriage, or the like, in place, or that prevents one or more carriages from moving in at least one direction (e.g., front to back or back to front) along the track, rail, or the like.

In the embodiment shown, the carriage locking mechanism 74 is generally formed by two opposing through orifices 76, 78 on a track, wherein the through orifices are adapted to receive a removable stop rod 80, or the like. The stop rod is generally adapted to prevent carriage 62 from traveling past the stop rod 80. In the embodiment shown the stop rod 80 is secured in place by a stop rod clasp 82, or the like.

In the embodiment shown, a set of carriage locking mechanisms 84, 86, 88, 90 is present such that, when deployed, they prevent the carriage 62 on each post assembly 30, 32, 34, 36, respectively, from traveling back past said locking mechanism. An additional set of carriage locking mechanisms 92, 94, 96, 98 is present such that, when deployed, they prevent the carriage 62 on each post assembly 30, 32, 34, 36, respectively, from traveling forward past said locking mechanism. The function and use of these carriage locking mechanisms will be explained in detail hereinafter.

While the figures show an embodiment having a particular carriage/track/locking mechanism, those of ordinary skill in the art will recognize that any type and arrangement of carriage/track/locking mechanism that fulfils the function herein required of it, or them, may be used. See, e.g., U.S. Pat. Nos. 5,494,327 and 6,547,311, which are incorporated herein by reference in their entirety as if fully set forth herein.

As shown in FIG. 2A, a convertible tonneau cover 10 in accordance with the present invention is generally adapted to be mounted on a pick-up truck 212, or the like. The pick-up truck 212 generally includes a passenger cabin 214 and a cargo bed 216. The cargo bed 216, before installation of the tonneau cover, is generally open on top, and enclosed by a left side panel 218, a right side panel 220, a front panel 222, a tailgate 224 and a floor 225.

The tonneau cover is generally installed onto a pick-up truck in any effective manner. Generally, the tracks, rails, or the like, 24, 26 are installed onto the top of the left and right side panels 218, 220. This may be accomplished in any effective manner. The carriages 62 are then generally mounted onto the tracks, rails, or the like, by sliding the carriages 62 from the back of the tracks, rails, or the like. While in the embodiment shown a particular type of tracks and carriages are used to slidingly mount the deployable tonneau onto the pick-up truck bed, any effective mechanism may be used for this purpose.

Once mounted onto the cargo bed 216, the rigid casing 12/structural framework 14 unit in a first position, shown in FIG. 2a, is adapted to securely cover the cargo bed 216.

The rigid casing 12/structural framework 14 unit is adapted to slide back to a second position, shown in FIG. 2b, such as to advantageously provide lateral access to the front portion of the cargo bed 216. The front portion of the cargo bed is a preferred location to store items for several reasons. For example, loose objects move less when placed at the front rather than at the back end of the cargo bed. Also, a better distribution of weight, and thus better handling, can be achieved if objects can be placed between the pick-up truck's two axles, which is generally roughly at the front end of the cargo bed. In addition, since the length of a cargo bed may make it difficult and inconvenient to access objects placed in the front of the cargo bed from the back of the truck, preserving lateral access to the front of the cargo bed is an advantageous feature for a cargo bed cover. As can be seen from FIGS. 2a and 2b, sliding back the tonneau cover in accordance with the present invention advantageously permits simple and easy lateral access to the front portion of the cargo bed. Accordingly, in another aspect of the present invention, a tool box, dividing wall, or the like, which is adapted to secure, keep, or the like, objects in the front portion of the cargo bed, may advantageously be used in combination with a tonneau cover of the present invention.

From the second position (illustrated in FIG. 2B), the rigid casing 12/structural framework 14 unit is adapted to be deployed to a third position (illustrated in FIG. 2C), where it may function as an overhead lumber-type rack.

The rigid casing 12/structural framework 14 unit may be held in place overhead by any effective securing mechanism. A securing mechanism may, for example, lock the hinges, the posts, or the rigid casing 12/structural framework 14 unit in place. These mechanisms may be used either alone or in combination. Tension cables, rods and the like may also be used.

In the embodiment shown, members of a mating latch type mechanism are used to secure the rigid casing 12/structural framework 14 unit in place. When present, members of a mating latch type mechanism may be located in any effective position. Generally, the type of locking mechanism shown should be located at a substantially forward position of the cargo bed on or about the same vertical plane as the cargo bed's front panel 222.

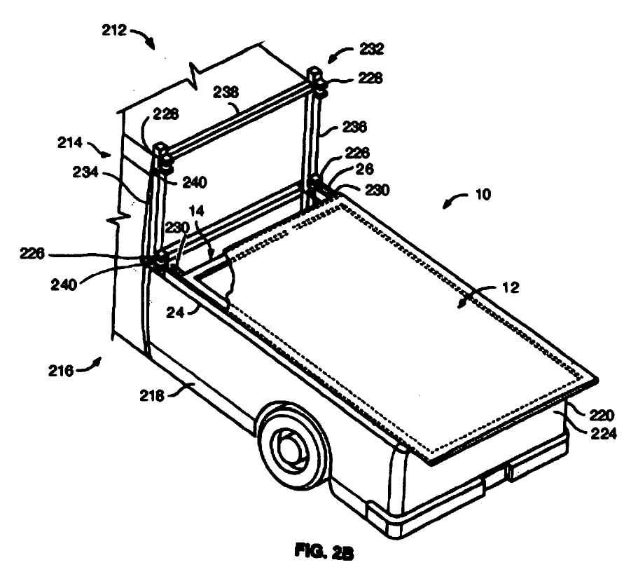

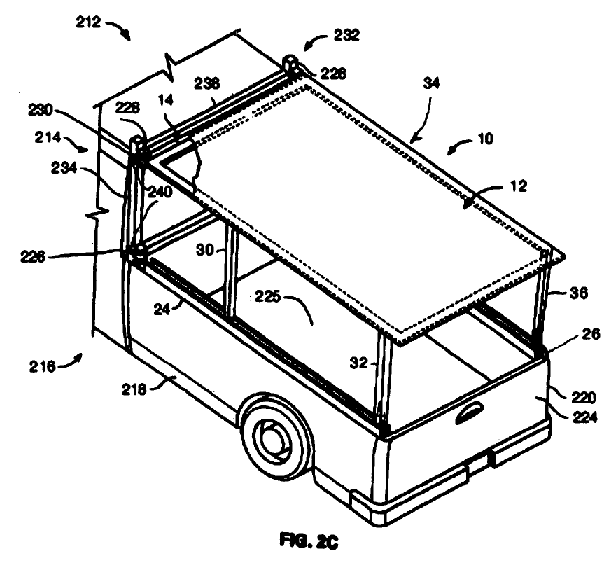

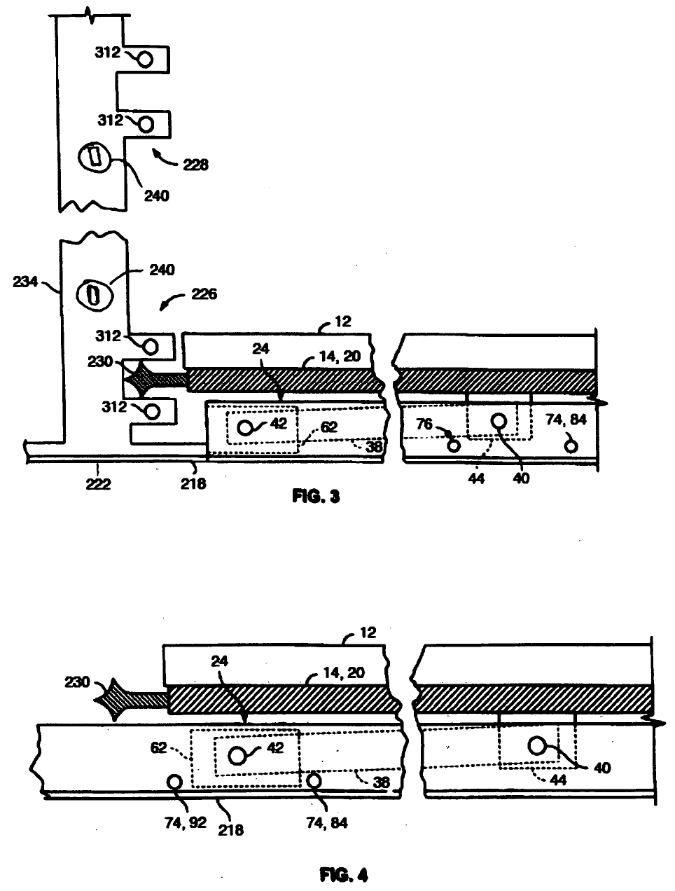

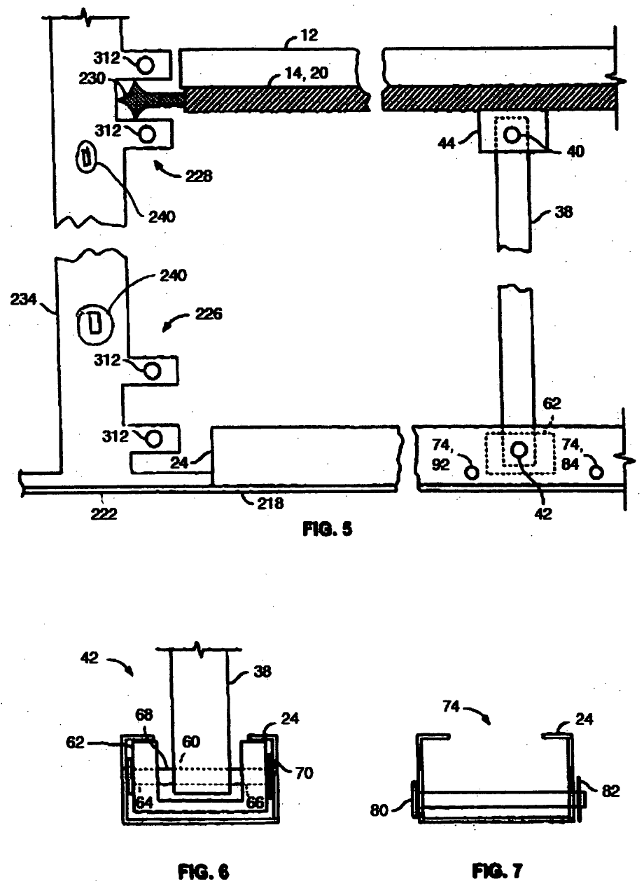

In the embodiment shown, lower 226 and upper 228 catch members are positioned such as to engage strike member 230 in rigid casing 12/structural framework 14, as further described in connection with in FIGS. 3 and 5. In the embodiment shown, lower 226 and upper 228 catch members are present on a latch support structure. When present, a latch support structure may be formed in any effective manner, including, for example, integrally with the pick up truck, or secured, affixed, or the like, to the pick up truck, either directly or through the track, rail, or the like. While in the embodiment the catch members are shown protruding from the latch support structure, the catch members may of course be disposed in any effective manner, including integrally with the latch support structure. The arrangement should be such that the rigid casing 12/structural framework 14 covers the truck bed in the closed position illustrated in FIG. 2A.

In the embodiment shown, the latch support structure is a front lumber rack type structure 232, which generally includes a non-pivoting, left, weight-bearing post 234, a non-pivoting, right, weight-bearing post 236 and a cross beam 238. In an alternative embodiment, the mating latch type structures may be present on the exterior of the back side of the passenger cab, or the like. When present, the cross beam 238 generally is at a height such that when long straight objects are placed above the cab 214 in a plane substantially parallel to the plane of the truck's wheel base, the objects may be supported by the latch support structure cross beam 238 such that the objects will clear the cab 214. In the embodiment shown, the latch support structure cross beam 238 is supported by the non-pivoting posts 234, 236 at a height that is slightly above the height of the exterior of the passenger cab 214.

As may be seen in more detail in FIG. 3, which is a schematic lateral cross section of FIG. 2A, in the embodiment shown lower catches 226 and upper catches 228 are present on non-pivoting posts 234, 236. The lower catches 226 are located in substantially the same plane as the rigid casing 12/structural framework 14 unit when the unit is in a closed position such that the lower catches 226 engage strikes 230, or the like, present reciprocally on the front edge of the rigid casing 12/structural framework 14 unit. In the embodiment shown, lower 226 and upper 228 catches include an actuatable mechanism 240 for retaining/releasing the strike 312. The latch formed by the strike/catch arrangement preferably is key actuated 240, thus advantageously permitting locking the rigid casing 12/structural framework 14 unit in place, thus securing the cargo bed when the tonneau is in the closed position, FIGS. 2a and 3, and preventing unauthorized lowering of the tonneau in the deployed position, FIGS. 2C and 5.

As may be seen in FIG. 4, which is a schematic lateral cross section of FIG. 2B, in the embodiment shown once the strikes 230 are released from the lower catches 226, the rigid casing 12/structural framework 14 unit may be slid back horizontally. In the embodiment shown, the post assemblies 28 travel with the rigid casing 12/structural framework 14 unit, as the carriages 62 slide along the tracks 24, 26 until their progress is impeded by the carriage back-travel stop/locking mechanisms 84, 86, 88, 90. Advantageously, the arrangement permits the complete removal of the rigid casing 12/structural framework 14 unit and post assemblies 28 by simply removing the carriage back-travel stop/locking mechanisms 84, 86, 88, 90 and sliding the whole structure off the back end of the rails 24, 26.

In the embodiment shown, from the second, “open” position, shown in FIG. 2B, the rigid casing 12/structural framework 14 unit may be elevated into the third, “deployed” position, shown in FIG. 2C, where the structure may function as an overhead lumber type rack. While the transition may be accomplished in any effective manner, in the embodiment shown the transition is generally accomplished by engaging one or more carriage forward-travel stop/locking mechanisms 92, 94, 96, 98 and exerting or causing the exertion of an up-and-forward force, or the like, upon the rigid casing 12/structural framework 14 unit. Because the carriage forward-travel stop/locking mechanisms 92, 94, 96, 98 prevent carriages 62 from moving forward, the up-and-forward force forces posts 38 to rotate, pivoting around the lower hinges 42 on their lower ends and the upper hinges 40 on their upper ends, thus vaulting the rigid casing 12/structural framework 14 unit into the third, deployed position, shown in FIG. 2c. One or more motors, hydraulic assists, gas springs, springs, or the like, may be present to assist in the elevation of the truck-bed cover 24 into said third position, and when lowering the truck-bed cover 24 from the third position back into the second position.

In the embodiment shown, at the end of the rigid casing 12/structural framework 14 unit's up-and-forward motion, one or more strike members 230, or the like, engage upper catch members 228, or another latch like mechanism, as shown in FIG. 5, thus securing the rigid casing 12/structural framework 14 unit in the third position. This arrangement whereby the deployed tonneau cover engages a latch support structure, or the like, at, or about, the same plane as loads will be placed on the overhead rack, greatly increases the load capacity and safety of the apparatus. For example, the arrangement preferably greatly decreases leveraged torque forces on the deployed post assemblies by transferring said forces to the support structure.

In use, the convertible tonneau cover 10 may be assembled and operated in any effective manner. Assembly is generally accomplished by securely bolting, clamping, soldering, or the like, the left and right tracks, rails, or the like, to the top of the left and right cargo bed panels, respectively, of a pick up truck. A latch support structure may be secured directly to the top of the left and right cargo bed panels or may be slid from the back onto the left and right tracks, rails, or the like.

Each post assembly is generally assembled by hingedly connecting a first end of a post to the cover and the other end to a carriage. The front carriages are then slidingly engaged and slid forward from the back end of the rails, followed by the back carriages. Carriage back-travel stop/locking mechanisms are then engaged to prevent the structure from sliding off the back end of the rails. The tonneau cover generally may be deployed into the overhead rack position, by sliding the tonneau cover back until the carriages engage the carriage back-travel stop/locking mechanisms. The carriage forward-travel stop/locking mechanisms are then deployed such that the carriages are also substantially incapable of traveling forward along the rails, and such that applying a forward and upward force to the tonneau cover propels the tonneau cover up and forward, vaulted by the pivoting post assemblies. The deployed tonneau cover is then generally held in place by a locking-type mechanism.

Thus, a novel deployable tonneau cover has been shown and described. Many changes and modifications can of course be made without departing from the spirit and scope of the invention. The invention, therefore, should not be limited, except by the following claims, and their equivalence.

1. A tonneau cover deployable into a lumber-type rack, which comprises:
a casing adapted to securely cover a pick-up truck bed;
a left track and a right track, said left and right tracks being adapted to be securely attached to left and right cargo bed side panels of a pick-up truck bed, respectively, and further adapted to slidingly engage one or more carriages;
one or more post assemblies, wherein a post assembly comprises:
a post having a first end and a second end;
an upper hinge, the upper hinge adapted to pivotally connect the post's first end to the casing;
a carriage, the carriage comprising:
a structure adapted to engage and slide along a track;
a lower hinge, the lower hinge adapted to pivotally connect the post's second end to the carriage;
a carriage locking mechanism;
a securing mechanism adapted to releasably secure the tonneau cover in the deployed position;
wherein the assembled tonneau cover is adapted to slide back from a first position where the tonneau cover secures the pick-up truck bed to a second position where the front portion of the pick-up truck bed is exposed and from said second position the tonneau cover is deployable into a third position where it may function as a lumber type rack.

2. A truck bed cover deployable into a lumber rack, which comprises:
a truck bed cover adapted to securely cover a truck bed;
a first load bearing structure functionally attached to the cover, the first load bearing structure adapted to define a load bearing plane substantially parallel to that of a truck bed;
a sliding mechanism adapted to permit the truck bed cover to slide horizontally from a first position where the truck bed cover covers a whole truck bed to a second position where the front portion of a truck bed is not covered by the truck bed cover;
a second load bearing structure functionally attachable to a truck bed and functionally engageable to the first load bearing structure, the second load bearing structure adapted to be deployable into a substantially vertical load bearing position and adapted to lift the truck bed cover and first load bearing structure from the second position to a third position in which the load bearing plane defined by the first load bearing structure is substantially parallel to a truck bed at a height that clears a roof of a passenger cabin of a truck.

3. (canceled)

4. A tonneau cover deployable into a lumber-type rack, which comprises:
a thin rigid casing adapted to securely cover a pick-up truck bed;
a structural framework defining a plane parallel to said rigid casing and functionally attached to said rigid casing, the structural framework comprising a front cross-beam and a back cross-beam connected by a left beam and a right beam;
a left track and a right track, said left and right tracks being adapted to be securely attached to left and right cargo bed side panels of a pick-up truck bed, respectively, and further adapted to slidingly engage one or more carriages;
front left, back left, front right and back right, post assemblies, each post assembly comprising:
a post having a first end and a second end, each end having a through orifice adapted to receive a rod;
an upper hinge, the upper hinge adapted to pivotally connect the post's first end to the structural framework, the upper hinge being formed by a structure comprising:
an upper hinge plate connected to the structural framework, the upper hinge plate comprising a through orifice;
an upper hinge rod;
an upper hinge clasp;
wherein the upper hinge is formed by threading the upper hinge rod through the upper hinge plate through orifice and the post's first end through orifice and securing the upper hinge rod with said upper hinge clasp;
an upper hinge hyperextension prevention mechanism, the upper hinge hyperextension prevention mechanism comprising a plate connected to the structural framework and adapted to prevent the post from pivoting substantially past a 90 degree angle with said structural framework;
a carriage, the carriage comprising:
a structure adapted to engage and slide along a track;
a lower hinge, the lower hinge adapted to pivotally connect the post's second end to the carriage, the lower hinge being formed by a structure comprising:
a hinge plate connected to the carriage, the hinge plate comprising a through orifice;
a lower hinge rod;
a lower hinge clasp;
wherein the lower hinge is formed by threading the lower hinge rod through the carriage hinge plate through orifice and the post's second end through orifice and securing the lower hinge rod with said lower hinge clasp;
a lower hinge hyperextension prevention mechanism, the lower hinge hyperextension prevention mechanism comprising a plate connected to the carriage and adapted to prevent the post from pivoting substantially past a 90 degree angle with said carriage;
a carriage back-travel locking mechanism and a carriage forward-travel locking mechanism, the locking mechanisms comprising:
a through orifice in one of said tracks;
a removable stop rod;
a stop rod clasp;
wherein the locking mechanism is formed by threading the stop rod through a track through orifice and securing the stop rod with said stop rod clasp such that said stop rod prevents said carriage from traveling past said locking mechanism;
a securing mechanism adapted to secure the tonneau cover in the deployed position, the securing mechanism comprising:
a strike member on said structural framework;
a catch member adapted to be affixed to a pick-up truck;
wherein the catch member is adapted to be affixed on a pick-up truck location such that when said strike member engages said catch member, the tonneau cover is secured in the deployed position;
an actuatable mechanism adapted to release said strike member from said catch member.
